(19) United States
(12) Patent Application Publication
(10) Pub. No.: US 2026/0071927 A1
(43) Pub. Date: Mar. 12, 2026

(54) PRESSURE SENSOR SYSTEM

(71) Applicant: Absolute Accuracy, LLC, Houston, TX (US)

(72) Inventors: Donald Keith Lincoln, Sioux Falls, SD (US); Kaushik Parekh, Houston, TX (US)

(73) Assignee: Absolute Accuracy, LLC, Houston, TX (US)

(21) Appl. No.: 19/320,904

(22) Filed: Sep. 5, 2025

Related U.S. Application Data
(60) Provisional application No. 63/691,582, filed on Sep. 6, 2024.

(51) Int. Cl. G01L 19/08; G01L 19/00; G01L 19/12

(52) U.S. Cl. CPC G01L 19/086; G01L 19/0092; G01L 19/12

(57) ABSTRACT

Aspects of the subject disclosure may include, for example, receiving data from a group of sensors that are connected to pressurized cylinders; and wirelessly transmitting, over a network, the data to a management platform that causes the management platform to make the data accessible to one or more communication devices. Other embodiments are disclosed.

### CROSS-REFERENCE TO RELATED APPLICATION(S)

The present application claims the benefit of priority to U.S. Provisional Application No. 63/691,582, filed Sep. 6, 2024, all sections of the aforementioned application(s) and/or patent(s) are incorporated herein by reference in their entirety.

### FIELD OF THE DISCLOSURE

The subject disclosure relates to a method and system for managing pressurized equipment utilizing a pressure sensor.

### BACKGROUND

Breathing air systems are used for various industrial and commercial applications, providing a reliable source of clean air for users. These systems are typically delivered to customer locations, where they are moved to different work areas as needed. This mobility introduces several challenges for suppliers and users alike. Suppliers often lack visibility into the location and usage of the systems, making tracking how much air has been consumed difficult. Additionally, maintenance records and air quality test logs are frequently kept manually, leading to potential gaps in information and delayed maintenance actions.

Current solutions do not adequately address these issues, resulting in difficulties such as uncertainty about the system's location, the amount of air remaining, and the need for maintenance. Manual record-keeping for air quality tests can lead to inaccuracies and non-compliance with safety standards. These limitations highlight the need for a more integrated and automated approach to monitoring and managing breathing air systems.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a system in accordance with various aspects described herein.

FIG. 2 is a block diagram illustrating an example, non-limiting embodiment of a portion of the system of FIG. 1 in accordance with various aspects described herein.

FIGS. 3 and 4 are block diagrams illustrating example, non-limiting embodiments of portions of the system of FIG. 1 in accordance with various aspects described herein.

FIGS. 5 and 6 are block diagrams illustrating exemplary, non-limiting embodiments of systems and delivered information in accordance with various aspects described herein.

FIG. 7 depicts an illustrative embodiment of a method in accordance with various aspects described herein.

FIG. 8 is a block diagram of an example, non-limiting embodiment of a computing environment in accordance with various aspects described herein.

FIGS. 9 and 10 are block diagrams illustrating example, non-limiting embodiments of portions of a system in accordance with various aspects described herein.

FIGS. 11 and 12 are block diagrams illustrating example, non-limiting embodiments of portions of a system in accordance with various aspects described herein.

### DETAILED DESCRIPTION

One or more of the exemplary embodiments provide management functionality and/or hardware for gas systems, such as breathing air systems. In one embodiment, a hazardous location approved device is provided that can integrate a pressure sensor and air quality wireless device into a single unit that is approved for use in hazardous locations. In one embodiment, multiple pressure sensor readings are provided such as via a device capable of reading data from multiple pressure sensors, and/or providing comprehensive monitoring of the equipment or system. In one embodiment (e.g., in combination with providing pressure and/or location data), an airflow and air quality detection method and system is provided which can detect airflow through the system (and/or in/through individual tanks and/or lines) and can analyze the quality of the air, ensuring that the air meets required standards. In one embodiment, automated alerts can be provided such as enabling the system to send text and/or email messages when equipment (e.g., pressure tanks) are out of compliance, which can enhance safety and maintenance efficiency. In one embodiment, remote monitoring and mapping is provided in which a device can send GPS location and device data to a remote host (e.g., automatically), which can include displaying the status of equipment (e.g., pressure in a tank) on a map for improved decision-making and/or quick location tracking.

In one embodiment, geofencing and movement alerts can be provided by a system which includes geofencing capabilities, such as providing notifications when equipment (e.g., tanks, manifolds, sensors, and so forth) move outside of specified zones. In one embodiment, comprehensive data integration can be provided through a multi-tier web application that converges information from multiple monitoring devices, which can include presenting the information together for improved decision-making. In one embodiment, personal safety features can be provided by way of a system that offers visible usage of air over-time (e.g., through graph displays or other indicia), and/or which provides visual, text, and/or email notifications for low gas/air alerts. In one embodiment, automated air quality testing can be provided via a system that performs automated air/gas quality testing and sends alerts or other notifications for out-of-spec (e.g., outside a threshold) and/or overdue testing. In one embodiment, maintenance visibility can be provided using a system which logs air/gas quality tests and provides alerts/notification for out-of-spec conditions and overdue hydro test dates of cylinders, enhancing maintenance visibility and compliance.

One or more of the exemplary embodiments can facilitate management of the equipment (e.g., tanks) regardless of their location, such as tanks in use at a facility and/or tanks in the yard which can be delivered to a customer.

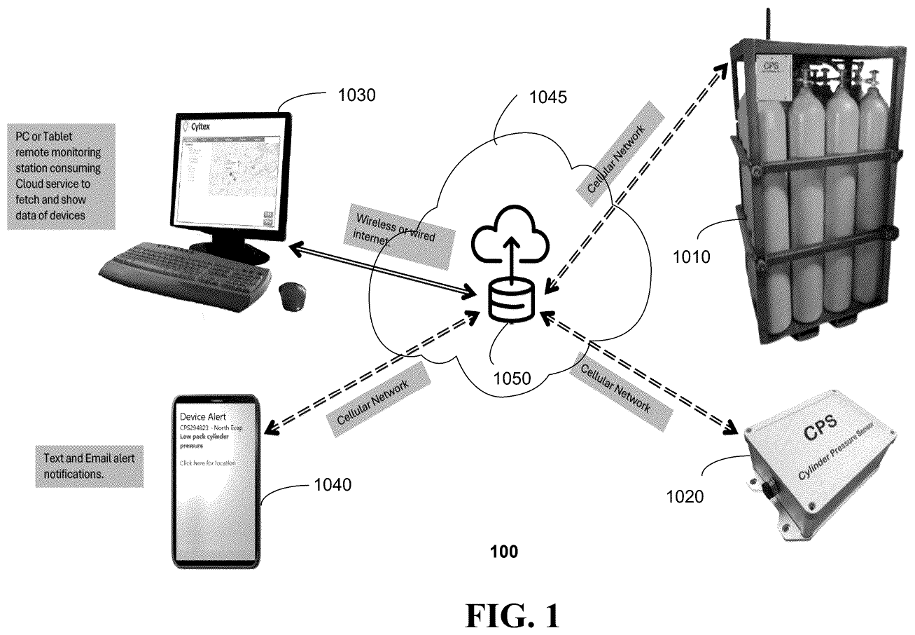

FIG. 1 shows an overview of system 100 that can be utilized for monitoring and managing gas systems, such as a breathing air system (e.g., utilized by cleaning technicians at a refinery). However, system 100 can be utilized for managing other pressurized gas equipment. System 100 can include one or more communication devices 1030, such as a personal computer, tablet, laptop, mobile phone, etc. Device(s) 1030 can consume Cloud services (e.g., via management platform 1050) to fetch and show data related to equipment 1010, which are illustrated as gas tanks but can be any equipment that contains pressurized gas. While one cluster of tanks is illustrated, it should be understood that the equipment 1010 being managed and monitored can come in various sizes, shapes and configurations. Other components (not shown) can be utilized with the equipment 1010 including regulators, manifolds, air lines, masks, and so forth. In one embodiment, the equipment 1010 can include a housing, package or other structure that carries the cylinders (e.g., a metal housing that is configured to be moved by a forklift). In other embodiments, the devices 1030 can collect the data utilizing other techniques including direct communication with monitoring devices as described herein. The communication techniques can include various types and combinations of types including cellular (e.g., 5G and Next Generation), WiFi, and so forth.

As an example, the PC or Tablet remote monitoring station 1030 can utilize a Cloud service platform 1050 operating in or otherwise connected with network 1045 to serve as a central monitoring hub for equipment 1010 (as well as other equipment that is to be managed and monitored). As will be described, device 1030 allows for fetching data from various monitors through Cloud services and further allows for displaying status and/or location of the various equipment 1010 so as to operate as a remote monitoring station viewer.

In one or more embodiments, Cylinder Pressure Sensor (CPS) unit 1020 can be installed with respect to the equipment 1010, as will be described herein where the sensor can determine pressure with respect to the cylinders. In one or more embodiments, the CPS unit 1020 can integrate a pressure sensor and an air quality component (e.g., a wireless device) into a single unit which can be approved for use in hazardous locations. The CPS unit 1020 can read data from multiple pressure sensors such as connected to each of the cylinders in the equipment 1010, and can detect pressure and/or airflow with respect to the equipment, and/or analyze the quality of the air. It should be understood that various configurations and techniques can be utilized for connecting the pressure sensors and the cylinders of the equipment 1010 including utilizing a cascade arrangement, connecting pressure sensors to safety valves of each cylinder, connecting the pressure sensor to lines that are run from the safety valves, and/or connecting the pressure sensor to lines that are otherwise connected to the cylinders for airflow.

In one embodiment, wireless and/or wired communications, including via the Internet, can provide the necessary connectivity for the system 100 as depicted by network 1045. These components can ensure that data from the CPS unit 1020 and/or other devices (e.g., separate air quality sensors) can be transmitted to the cloud and subsequently accessed by the communication device(s) 1030. It should be further understood that management platform 1050 can be operated in other fashions including centralized or distributed fashions, which may or may not be cloud-based, including by being hosted by one or more servers or other computing devices.

In one embodiment, system 100 provides notifications to various end user devices 1040, as well as presenting the information at the communication device 1030.

For example, end user device 1040 can be a mobile phone of the safety manager at the refinery and an SMS message can be delivered indicating that equipment 1010 (e.g., which is in use) has a pressure reading that has crossed below a threshold. In other embodiments, an alarm, light or other indicator can be provided on the CPS unit 1020 to provide a local notification, such as when a low-pressure reading is detected or an air quality outside of an acceptable range is determined.

In one embodiment, system 100 can connect with a cellular network (represented generally by network 1045 in FIG. 1) to facilitate the communication between the CPS unit 1020 and the management platform 1050. This network enables the transmission of data, including air pressure readings, airflow quality, and GPS location, such as to a preconfigured cloud remote IP based on a user-configurable time schedule.

In one embodiment, system 100 can provide text and/or email alert notifications to send automated alerts when the equipment 1010 is out of compliance with a user configured threshold or a regulatory threshold. This includes notifications for low air alerts, out-of-spec air quality, and overdue maintenance requirements, enhancing safety and maintenance efficiency. In one embodiment, a device alert can be generated which is illustrated as being presented by the UE 1040 for immediate notifications (e.g. for particular circumstances), alerting users to any issues that require attention. This can work in conjunction with the texts or emails to ensure comprehensive alerting capabilities.

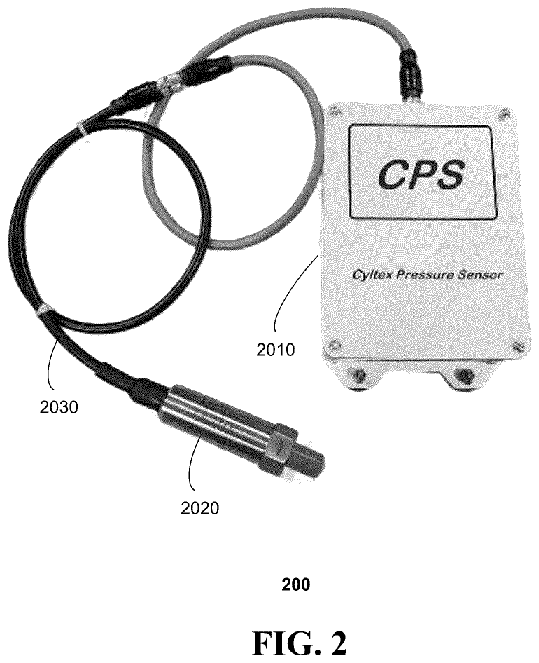

FIG. 2 illustrates a portion 200 of the system described herein that includes a CPS 2010 which can be installed with respect to the equipment (e.g., package of cylinders), where one or more sensors can determine pressure with respect to the cylinders. In this example, the CPS 2010 can be connected to a group of wires or cables 2030 (one of which is shown) with a pressure sensor 2020. The CPS 2010 can read data from multiple pressure sensors such as connected to each of the cylinders in the equipment, and can detect pressure and/or airflow with respect to the equipment, and/or analyze the quality of the air. It should be understood that various configurations and techniques can be utilized for connecting the pressure sensors and the cylinders of the equipment including utilizing a cascade arrangement, connecting pressure sensors to safety valves of each cylinder, connecting the pressure sensor to lines that are run from the safety valves, and/or connecting the pressure sensor to lines that are otherwise connected to the cylinders for airflow.

In one or more embodiments, the system and methodology enable tracking of air quality via air quality testing. As an example, this can be performed in conjunction with pressure monitoring as described herein. For instance, a user or administrator can access the system (e.g., remotely such as from a control center at the location or remote from the location of the pressurized tanks) to perform and/or obtain air quality testing measurements or metrics. In some embodiments, the air quality testing can be automated, including pursuant to a particular fixed or dynamic schedule, in response to a request, in response to a trigger by a particular event (e.g., cylinder or manifold pressure falls outside of a threshold level including above or below the threshold), and so forth.

Air quality testing can be performed according to various standards (e.g., OSHA, NIOSH, CGA, NFPA, and/or EN12021). For instance, testing can detect Oxygen content, Carbon Monoxide (CO), Carbon Dioxide (CO₂), moisture (e.g., dew point/water vapor), oil mist/hydrocarbons, particulates/dust, Nitrogen balance, Volatile Organic Compounds (VOCs), and/or odor.

In one or more embodiments, the system and methodology enable obtaining and/or logging air quality metrics along with the concentration, and other information such as user collecting information, the sensor/device utilized, the time/date done—which can also include indicating the next due date for air quality testing.

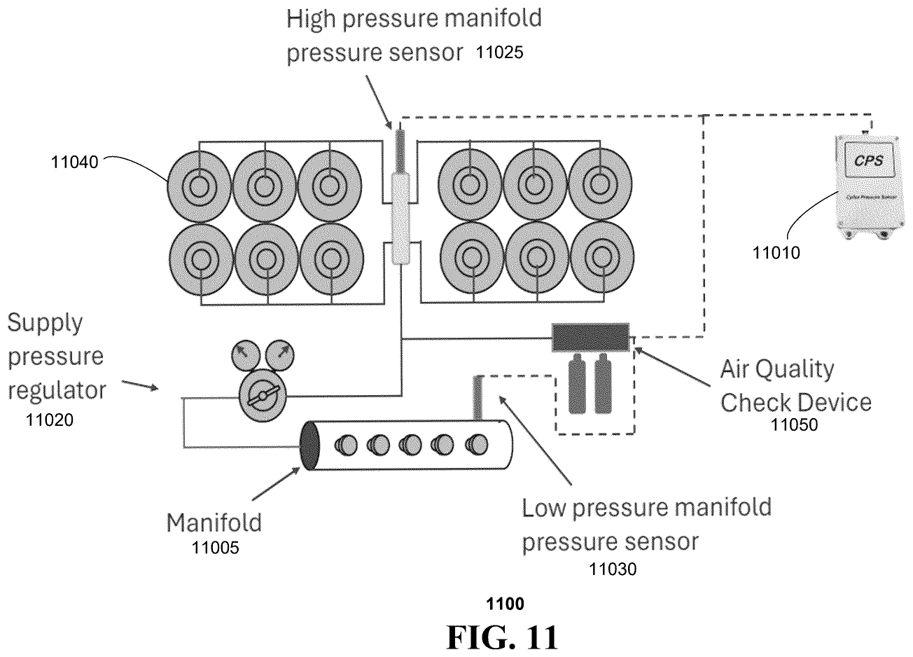

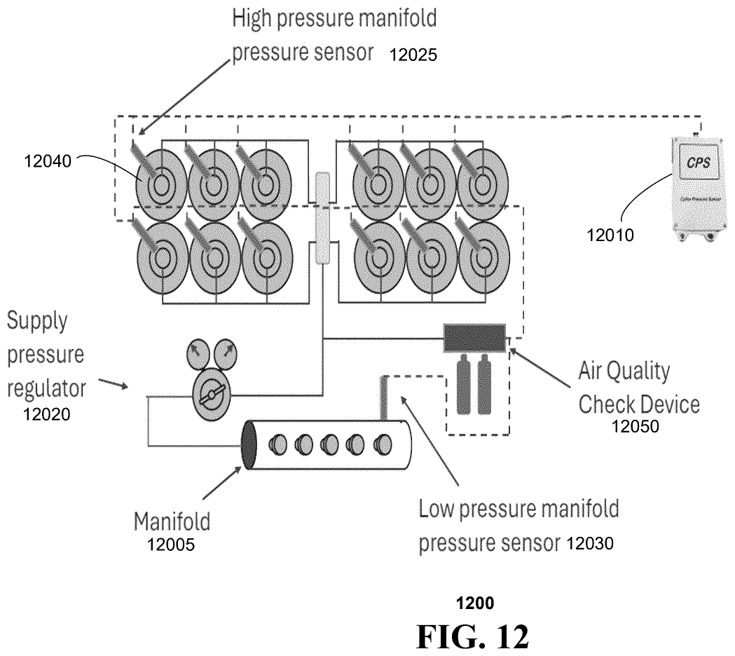

In one or more embodiments, the system and methodology enable an air-quality device (see air quality devices 11050, 12050 in FIGS. 11, 12) to collect relevant data (which can be a separate device such as an external device that connects to the pressure sensor cable and communicates in the same data path as the pressure sensors 2020). For example, the air quality device can include an air quality sensor that receives an air sample which is then tested and the results are provided, including according to the distribution/recording techniques and components described with respect to system 500 or other embodiments herein. The air quality device can be a separate component from CPS 2010 which is in communication with CPS 2010 via a wired and/or wireless communications for relaying the test results. Various components including valves, pressure relief devices, wiring, conduit, wireless radio, battery power, and so forth can be utilized with the air quality device to facilitate collecting air quality testing metrics and storing/distributing those results, which can include real-time reporting of air quality.

As an example, the air quality device can connect with or otherwise be coupled with (including via hoses/conduit and/or wirelessly) the pressure sensor 2020. The air quality sensor device can automatically (and/or according to a command such as via user input, via the CPS 2010 and/or via a remote server sending a command signal) pull an air sample into it and perform air quality tests, and then that information can be provided to relevant recipients and their devices such as through the CPS 2010. In one or more embodiments, the system and methodology enable collecting raw air quality metrics at the sensor of the air quality device, which can then be further analyzed such as via the CPS 2010 and/or via a remote server.

In one or more embodiments, the system and methodology enable the air quality device and/or the CPS 2010 to provide an alert to various users including users that are being exposed to the air (e.g., users wearing masks that are receiving the air) and/or to a centralized server or UE(s). For instance, certain air quality detection such as elevated CO2 or CO levels can result in an emergency alert sent out which can be sent to alarms built into the user masks, to UE(s) known to be in possession of the users of the masks, other personnel (or their UEs) in proximity to the users wearing the masks, and so forth.

In one or more embodiments, a calibration device (which can include a calibration cylinder(s) can be built into, connected with or otherwise coupled with the air quality device. The calibration device can automatically (and/or according to a command such as via user input, via the CPS 2010, and/or via a remote server sending a command signal) provide a calibration sample (such as powering up a solenoid or servo-motor that opens/closes a valve) to the air quality device to perform air quality tests, and then that information can be analyzed to confirm that the air quality sensor is calibrated and performing properly. In one or more embodiments, the calibration device can be provided to relevant recipients (or their UEs), such as through the CPS 2010, including to a centralized server, logging system, and so forth so that proper records are maintained for the accuracy and calibration of the system.

In one or more embodiments, the system and methodology enable collecting raw air quality metrics at the air quality device (for air believed to be of a certain quality since it is coming from the calibration cylinder of the calibration device) which can then be further analyzed such as via the CPS 2010 and/or via a remote server. This can be performed according to various schedules, including based on particular standards or other applicable safety guidelines. The calibration device and its calibration cylinder can be of various sizes which in some embodiments may be small enough to be built into or physically connected to the air quality device and/or can be a separate device that is coupled via tubing/conduit to deliver a calibrated air sample to the air quality device so that the calibration testing results can be obtained and provided to the CPS 2010.

In one or more embodiments, the system and methodology enable taking further actions when the calibration testing results in metrics that are outside of a particular threshold which may indicate that the air quality device is out of calibration or is not performing properly, or it may indicate that the air quality of the air in the calibration cylinder is not of the quality it is believed to be (e.g., the air quality within the calibration cylinder has deteriorated over time, or has been exposed to a contaminant such as dust/particles, etc.). These additional actions can include performing additional calibration testing, such as on-site using a separate calibration device and/or utilizing a separate calibration air cylinder.

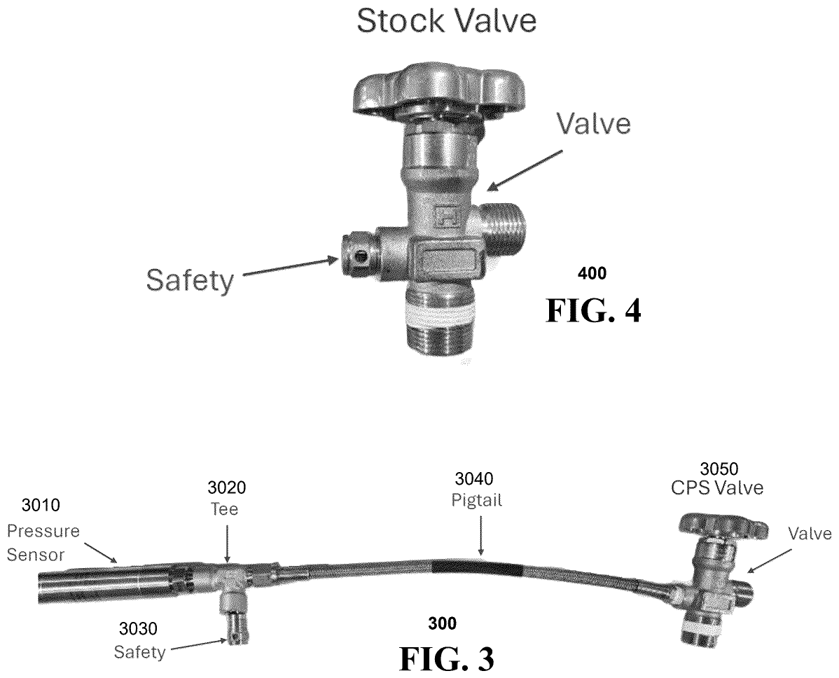

FIG. 3 illustrates a connection structure 300 for a CPS valve 3050 (the cylinder is not shown). The structure 300 can include a pigtail 3040 connected to a tee 3020 that allows for connection of both a pressure sensor 3010 (which is coupled to the CPS unit) and a safety valve 3030 (e.g., pressure-relief valve).

FIG. 4 illustrates a CPS valve 400 (the cylinder is not shown). The CPS valve 400 shows the safety valve coupled thereto which, as can be seen in structure 300 of FIG. 3, can be moved to the tee 3020.

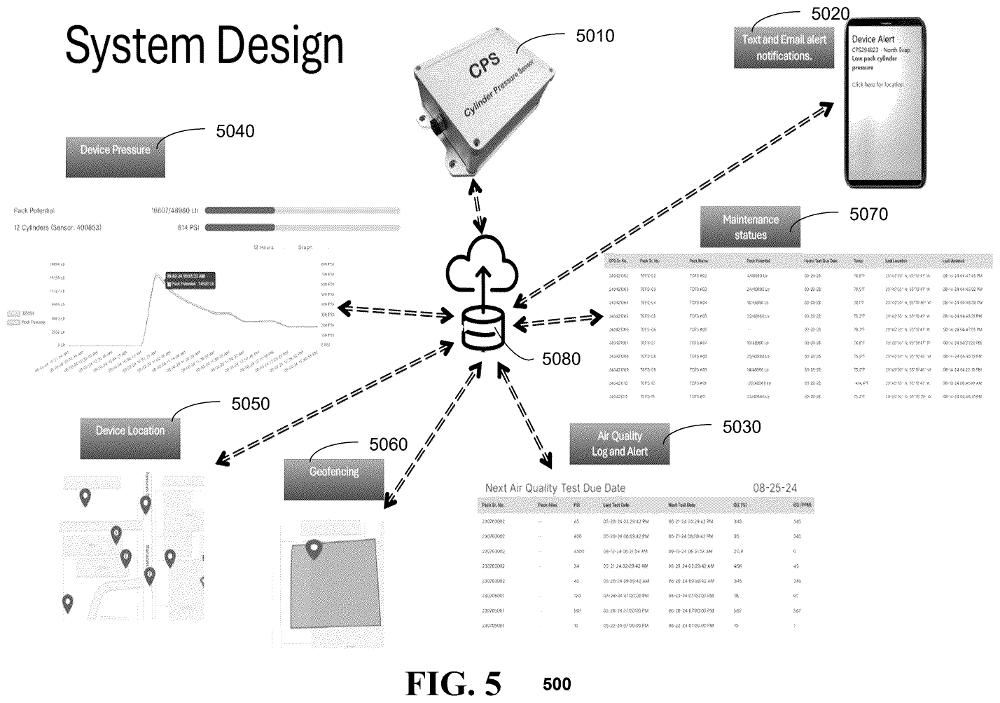

FIG. 5 shows an overview of system 500 and the information collected by CPS unit 5010 and delivered to the management platform 5080. The CPS unit 5010 (only one of which is shown but numerous can be utilized with each connected to a separate package of cylinders which can be located at a same job site or different job sites) can serve as a data collection point of the system 500. For example, CPS unit 5010 can be coupled to numerous sensors, such as pressure sensors, air quality sensors, and so forth, which can be approved for use in hazardous locations. CPS unit 5010 can read data from multiple sensors, detect airflow through the breathing system, and/or analyze the quality of the air. System 500 can be utilized with multiple packages of cylinders that can be located in different places.

Device pressure data 5040 can be presented to provide real-time monitoring of the pressure within the breathing air system (e.g., within the pressurized cylinders). This can include pressure readings and trends over time, allowing users to track the equipment performance and identify any potential issues.

Text and Email alert notifications 5020 can be sent as automated alerts when the equipment is out of compliance. This can include notifications for low air alerts, out-of-spec air quality, and overdue maintenance requirements, thus enhancing safety and maintenance efficiency. Other alert functionality can also be employed including emergency or urgent alerts that trigger noise and/or lighting, such as an air quality alert or a low-pressure alert being provided via a blinking LED at a user mask. In one embodiment, end user devices can present a Device Alert for immediate notifications on the device itself, alerting users to any issues that require attention. CPS unit 5010 can include some or all of the components and functionality of CPS 2010, including being in communication with an air quality device (e.g., operating as a separate device that is in communication with the CPS unit 5010). As described herein, the CPS unit 5010 can package or otherwise aggregate various information for distribution to particular recipients (e.g., their UEs/devices) including low air alerts, out-of-spec air quality, and/or overdue maintenance requirements.

Maintenance status data 5070 can include logs and other information regarding the current maintenance status of the equipment. This information can include the last maintenance performed, upcoming maintenance requirements, and any overdue maintenance tasks, ensuring that the equipment remains in optimal condition.

Device Location 5050 is information that tracks the geographical location of the cylinders. This information can be real-time location data, allowing users to monitor the equipment's position and ensure the equipment remains within designated areas.

Geofencing 5060 provides notifications when the equipment moves outside of specified zones. This information allows users to define customizable zones and receive alerts if the equipment leaves these areas, enhancing security and control over the equipment's location.

Air Quality Log and Alert data 5030 are records for monitoring the quality of the air within the equipment. This information can be based on automated air quality testing and can result in alerts being sent out for out-of-spec conditions, ensuring that the air meets required standards. In one embodiment, the system 500 can provide Next Air Quality Test Due Date which displays the scheduled date for the next air quality test. This information helps users keep track of testing intervals and ensures that air quality tests are performed on time, maintaining compliance with safety standards.

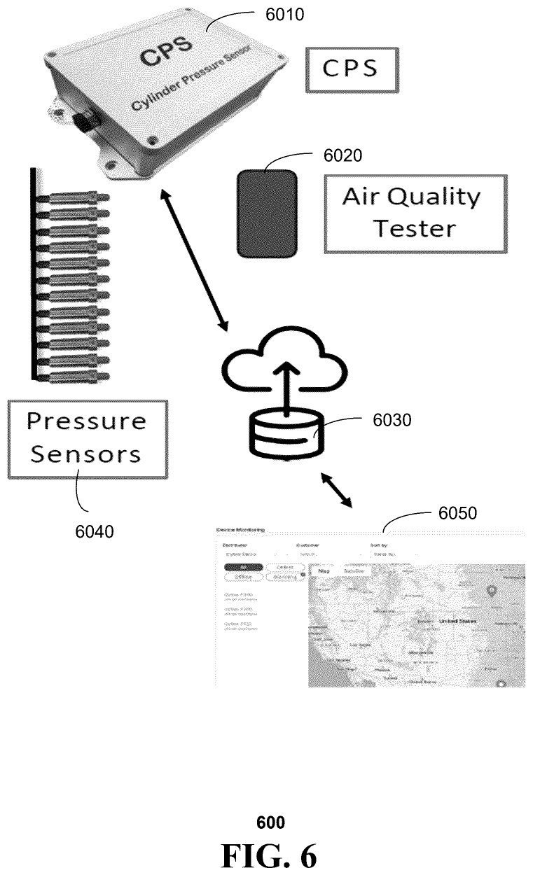

FIG. 6 illustrates a portion 600 of the system described herein that includes a CPS unit 6010 which can be installed with respect to the equipment (e.g., package of cylinders), where the sensor(s) can determine pressure with respect to the cylinders. In this example, the CPS 1020 can be connected to a group of pressure sensors 6040 and to an air quality tester 6020 (e.g. coupled to the manifold or otherwise connected to the system to sample the gas/air). The CPS unit 6010 can read data from multiple pressure sensors such as connected to each of the cylinders in the equipment, and can detect pressure and/or airflow with respect to the equipment, and/or analyze the quality of the air. It should be understood that various configurations and techniques can be utilized for connecting the pressure sensors and the cylinders of the equipment including utilizing a cascade arrangement, connecting pressure sensors to safety valves of each cylinder, connecting the pressure sensor to lines that are run from the safety valves, and/or connecting the pressure sensor to lines that are otherwise connected to the cylinders for airflow.

The CPS unit 6010 can transmit the collected data (e.g., via a cellular network) to a management platform 6030 (e.g., a cloud-based platform) for presentation of the collected data in various formats. For example, map 6050 can be presented which illustrates locations of various equipment, and which can provide a customer with access to various data associated with each of those equipment, such as pressure readings, air quality, battery power, maintenance deadlines, and so forth.

The CPS unit 6010 can include some or all of the components and functionality of CPS 2010 and/or 5010, including being in communication with an air quality device (e.g., operating as a separate device that is in communication with the CPS unit 6010). As described herein, the CPS unit 6010 can package or otherwise aggregate various information for distribution to particular recipients (e.g., their UEs/devices) including low air alerts, out-of-spec air quality, and/or overdue maintenance requirements.

In one or more embodiments, the system and methodology enable monitoring pressure, air quality and/or other metrics at various points of the air delivery system. For example, a first pressure sensor or set of pressure sensors can be positioned for determining storage pressure, which is a higher pressure and which could utilize higher pressure capacity sensors, and a second pressure sensor or set of pressure sensors can be positioned for determining manifold pressure or user pressure, which is a lower pressure and which could utilize lower pressure capacity sensors (which can be more sensitive to pressure changes).

In one or more embodiments, the system and methodology enable monitoring air quality at various points of the air delivery system. As another example, the air quality device can be a group of devices/sensors that are connected at or near each of the user masks and which are coupled with (including via wired and/or wirelessly) the CPS 6010. The air quality device can automatically (and/or according to a command such as via user input, via the CPS 6010, and/or via a remote server sending a command signal) pull an air sample into it and perform air quality tests, and then that information can be provided to relevant recipients such as through the CPS 6010. In one or more embodiments, the system and methodology enable collecting raw air quality metrics at the air quality device, which can then be further analyzed such as via the CPS 6010 and/or via a remote server. In other embodiments, the air quality device can be positioned at various points, including at or near the user masks, at or near the manifold, at or near the CPS 6010, and/or at or near the pressurized cylinders.

In one or more embodiments, monitoring such as of pressure, air quality and/or other metrics at various points of the air delivery system can enable proactive steps being implemented to improve performance of the system and ensure safety. For example, pressure adjustments can be made (e.g., remotely via a command signal) where a pressure drop is detected for air going into a particular user mask or to a particular manifold. In another example, cylinder source adjustments can be made (e.g., remotely via a command signal) where air quality of air going into a particular user mask or to a particular manifold may be outside of a threshold which may be due to a particular cylinder or set of cylinders having lower air quality. For instance, one of the cylinders may be removed as a source (e.g., through turning its valve to a closed position) if that cylinder is believed to be providing air of a lower air quality.

In one or more embodiments, pressure metrics, air quality metrics and/or other metrics at various points of the air delivery system can be analyzed to enable proactive steps being implemented to improve performance of the system and ensure safety by employing Artificial Intelligence (AI) modeling (including Large Language Models (LLMs)) in the analysis and/or in the determination of the action(s) to be taken. The AI modeling can utilize historical data, predictions, and other information in its analysis which can improve the response time, as well as the resulting performance. As an example, actions including pressure adjustments, cylinder replacement, cylinder source changes, equipment adjustment, equipment re-location, and so forth can all be enhanced through AI modeling, which can be implemented at a centralized server or other computing device which may or may not be located at the premises where the cylinders are located.

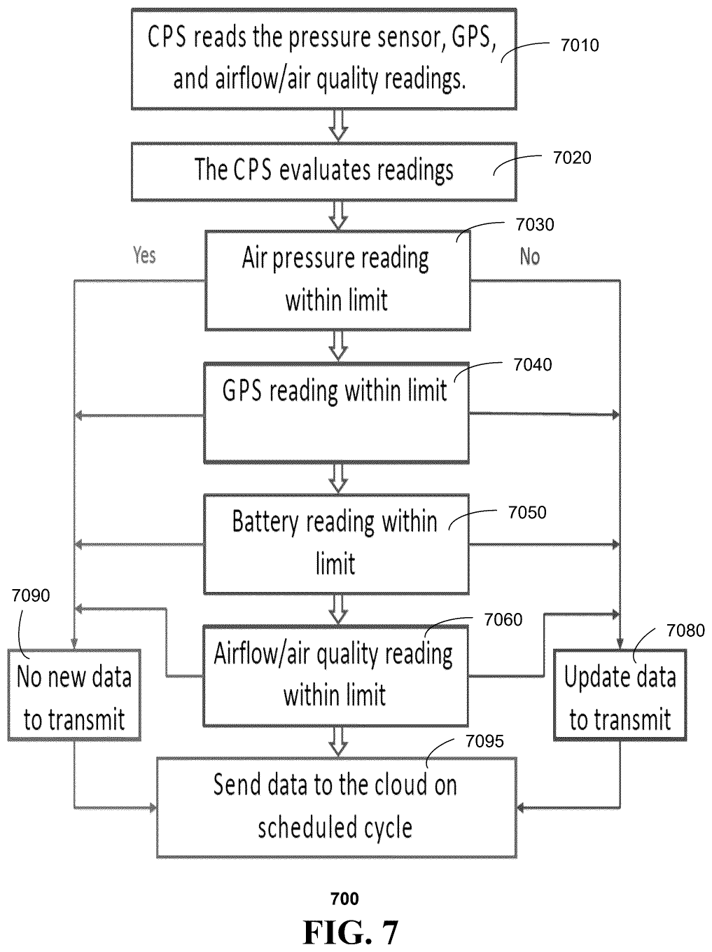

FIG. 7 illustrates a method 700 for managing equipment, such as pressurized cylinders for air breathing systems. At 7010, the CPS unit can read or otherwise obtain various data from sensors, such as pressure sensos, location devices, airflow meters, air quality sensors, and so forth. At 7020, the collected data can be evaluated, such as based on threshold, operating requirements, or other parameters, which in some embodiments can be user configured and/or adjustable.

At steps 7030-7060 each of the different types of collected data is evaluated to determine whether a data update is required at 7080 or whether there is no new data to be transmitted at 7090. At 7095, data can be transmitted to the management platform to allow for remote viewing of the data. It should be understood that other types of data and/or other flows can be used with respect to method 700.

Method 700 can be employed in whole or in part with the air quality functionality described herein, which can be employed alone or in conjunction with other metrics being managed in the method.

In one or more embodiments, the system provides visibility and management for expensive equipment, which may be rented out to another customer and who would normally not have any visibility on the product. For example, breathing air systems are often delivered to customer's locations (e.g., storage yard) and then the customer moves the system to where the work is being performed. The customer may not be notified of a movement of their equipment so the exemplary embodiments provide for efficient tracking, including geofences as described herein.

In one or more embodiments, the system provides a supplier with a method to know how much gas (e.g., air) has been used for the equipment that is rented out to a user. In one or more embodiments, the system provides up-to-date system maintenance records which may not always be readily available to a user utilizing the equipment, which can further include error test records.

In one or more embodiments, the system provides efficient inventory control such as knowing which cylinders are full, partially full, and empty, as well as whether the cylinders can be used or whether they first require maintenance.

In one or more embodiments, communication devices (e.g., desktop computers, laptop computers, mobile phones, vehicle computing systems, or other devices) allow logging into or otherwise accessing the software and the service which can be cloud-based (referred to herein as a platform). In one or more embodiments, the system provides cylinder pressure sensor(s) which communicate pressure information to the cloud, which can be done by a unit (i.e., referred to as a CPS herein) co-located with the cylinders. In one or more embodiments, the system can provide other information associated with the pressurized cylinders, such as battery power level, gas quality, flow rate, RF signal strength for the CPS unit, temperature, or other data that can be sensed or otherwise collected from the equipment (i.e., the pressurized cylinders or tanks). In one or more embodiments, the system provides location data based on GPS capabilities associated with the CPS unit, although other techniques and/or hardware can be utilized for collecting location information for the equipment.

In one or more embodiments, the system provides for various techniques for communicating the information to various users/personnel such as via SMS or emails, which can be pushed and/or pulled to/by users. In one or more embodiments, the system provides notifications based on customer specific parameters, such as pressure thresholds, pressure change threshold, schedules, and/or other events that can trigger a notification.

In one or more embodiments, the system provides notification as to maintenance history, scheduled maintenance and/or events, such as a hydrotest due date. In one or more embodiments, the system provides a user with the capability of customizing the information that is being obtained such as pressure readings, location data, air quality, and/or maintenance information. In one or more embodiments, the system can send this information via notifications to end user devices, such as a mobile phone of the yard foreman that is managing the inventory (e.g., while the foreman is in the yard), but can also make this information available at the personal computer or other communication device that is executing or accessing the software (described herein as device 1030 in FIG. 1), such as in the customer's office.

In one or more embodiments, the system provides for notifications to be provided to third parties that may need to interact with the equipment, such as a maintenance reminder being sent out to a maintenance company that does inspections or testing of the cylinders. In one or more embodiments, the system can provide automation of the equipment management process. For example, this can include Artificial Intelligence or algorithms that determine which equipment is to be supplied to a customer according to various historical, current and/or predicted factors, such as gas pressure, job requirement, length of use, number of team members using the equipment, cost, distance to job site, maintenance history, maintenance requirements, and so forth. For instance, the system can determine that a particular equipment that is only at 60% capacity of gas is to be delivered to a job site that is requesting the equipment for ten days because historically there has only been a team of two persons utilizing the equipment at that job site, while a determination is also made that different equipment which is at 100% capacity of gas is to be delivered to another job site that is requesting the equipment for only two days because historically there has been a team of twelve persons utilizing the equipment at that other job site. Other factors can also be utilized in managing the equipment, including maximizing efficiency in use of the cylinders.

In one or more embodiments, the system allows for control over the sharing of the collected information such as a customer who leases equipment to different refineries and allows personnel at the refineries (e.g., a safety manager) to access information that is associated only with his or her refinery, while the customer would have access to all of the information for all of the customer's equipment that is being leased or rented out.

In one or more embodiments, the system provides a CPS unit that has a wired connection to pressure sensors that are connected to (e.g., directly or indirectly) the cylinders. The CPS unit in turn can have a bidirectional wireless connection(s) (e.g., cellular, WiFi, and so forth) so as to deliver/receive the data/instruction to/from the service platform (e.g., in the cloud) and then to the communication devices. In one or more embodiments, the system can be multi-modal so that it can use different Radio Access Technologies to deliver and/or receive information.

In one or more embodiments, the system provides for management of various configurations of pressurized tanks, including a six, twelve or twenty pack horizontal package or a tube bundle configuration (e.g., on a trailer).

In one or more embodiments, the system can utilize wireless (and/or wired) pressure sensors and/or other sensors (e.g., air quality, flow rate, location, etc.) that communicate with the CPS unit.

In one or more embodiments, the system utilizes components, such as sensors that are approved for a hazardous location. In one or more embodiments, the system can utilize sensors that communicate via a short-range communication, such as Bluetooth.

In one or more embodiments, the system can provide digital pressure sensors installed on each cylinder before the on/off valve. For example, the pressure relief device can be used for a connection to constantly read the pressure of the cylinder.

In one or more embodiments, the system can have a CPS unit that sends the data or information based on a user configurable time schedule to a preconfigured destination, such as a cloud platform via a cellular or other network. The data can then be shown at one or more remote monitoring stations (e.g., desktop computers that access the cloud platform or otherwise execute software providing the functionality described herein).

In one or more embodiments, the system can allow for polling of the data from the CPS unit, which can be capable of bidirectional communication.

In one or more embodiments, the system can push data from the CPS unit to the platform (e.g., enabling access to the remote viewing stations such as the customers desktop) according to an adjustable schedule (and/or can enable polling of data at any time).

In one or more embodiments, the system can employ event driven data transfer such as when a cylinder pressure change rate goes from −5% per hour to −20% per hour or when a PSI of a cylinder goes below a threshold such as below 35% of capacity then the CPS unit provides the information (e.g., a pressure reading).

In one or more embodiments, the system can provide information triggered by emergency situations, such as a battery level and/or pressure level falling below a threshold. In this example, this can further result in an adjustment of the frequency (i.e., how often) of transferring data, such as sending data more often when the pressure is lower in the cylinder so that a customer can more closely monitor the cylinders.

In one or more embodiments, the system can adjust frequency of pushing data from the CPS units according to other factors, such as age of a cylinder, maintenance history, upcoming maintenance deadlines, etc.

In one or more embodiments, the system can detect percentages of gases (e.g., oxygen, nitrogen and everything else in the air) through use of air quality sensors which can be positioned at various locations including on the cylinder, in the line from the cylinder, in the manifold, in a line from the manifold to the user's mask, in the mask, and so forth. Similarly, in one or more embodiments, the system can position various sensors (including the pressure sensors) at various locations including on the cylinder, in the line from the cylinder, in the manifold, in a line from the manifold to the user's mask, in the mask, and so forth. The use of wireless sensors that can capture data and transmit the data to the CPS unit can facilitate this functionality.

In one or more embodiments, when a cylinder is turned on and air pressurizes into the manifold, then a sample of that air can be diverted off into a sensor, which will measure gases (e.g., carbon monoxide levels, oxygen concentration, and so forth) and then that information can be provided by the sensor to the CPS unit (e.g., via a wired or wireless connection), which will then relay that information to the cloud platform or otherwise provide the information for remote viewing by the customer. Air quality measurements can be performed on a per cylinder basis and/or on groups of cylinders (such as via the manifold).

In one or more embodiments, the system can provide time and date stamps with pressure reading, air quality, gas concentrations or other information which can be stored for historical reasons. This can allow a customer to quickly ascertain when air was last tested and whether it was within an acceptable range.

In one or more embodiments, the system can satisfy governmental regulations and requirements, such as inspection or hydrotesting.

In one or more embodiments, the system can track cylinder serial numbers along with the collected information and maintenance records.

In one or more embodiments, the system can provide lines with sensors and pipe thread to facilitate threading the adapter into the cylinder.

In one or more embodiments, the cylinder packages can have a main manifold and a regulator that regulates down that pressure to a usable pressure. Each of the cylinders can have a hose that attaches to the manifold (e.g., a pipe). User lines (e.g., with user masks attached thereto) can then be directly connected to the manifold. Other types of cylinder/package configuration can also be utilized.

In one or more embodiments, the system can generate trending screens based on the collected data such as providing a slope for the change in pressure. In one or more embodiments, the system can illustrate trends of gas usage and device location, which is sortable online/offline.

In one or more embodiments, the system can have a GUI that illustrates each of the equipment in a particular location (e.g., an icon or indicia shown on a map). As an example, a user can select the icon (e.g., click on it) which can provide relevant information. In another embodiment, the GUI can list each of the equipment and selection of the equipment from the list can zoom in on the equipment in its location on a map.

In one or more embodiments, the system can have a GUI that provides for geofencing functionality. For example, a user can set parameters that create a geofence to determine whether equipment is moved out of (or into) a location(s). So, if the equipment moves inside or outside of that geofence area, then a user can receive notifications such as texts and/or emails.

In one or more embodiments, the system can have a GUI that presents a maintenance status report for each of the cylinder packages. In one or more embodiments, the system can have a GUI that presents air quality logs for each of the cylinders and/or each of the package of cylinders. In one or more embodiments, every time a pack of cylinders is energized, the CPS unit can test the air and then send the data for remote viewing. Additionally, notifications can go out to particular end user devices such as where air quality is below a threshold or the other measured parameter(s) is outside of spec.

In one or more embodiments, the system can selectively push information, such as according to a type of information (e.g., pressure measurements) and/or according to whether or not the data is within acceptable limits. In one or more embodiments, the system can selectively communicate utilizing Wi-Fi, cellular, and satellite communication.

In one or more embodiments, the system can select a Radio Access Technology according to the particular circumstances, such as based on signal strength, cost, and so forth. In one or more embodiments, the system can provide recommendations to a user such as predicting when a package of cylinders should be replaced. As an example, these predictions can be based on various algorithms utilizing historical usage information, and can be in some embodiments determined utilizing Artificial Intelligence. In other embodiments, maintenance recommendations, including timing and type of service can be recommended for cylinder packages. This functionality can be based on various factors including analysis of historical maintenance information, usage information, and so forth. In one embodiment, Artificial Intelligence can be utilized to make predictions and recommendations regarding maintenance.

In one or more embodiments, the system can measure the rate at which a gas is being used and compare it against the volume to provide predictions or recommendations to users, such as a notification that a package of cylinders will likely run out at a particular time and/or that a delivery of another package of cylinders should be scheduled for a particular date.

In one or more embodiments, the system can make predictions as to usage based on historical usage data in combination with other information such as a number of members of the team that are scheduled to work and will be utilizing the equipment. In one or more embodiments, the system can collect data at a manifold (e.g., air quality and air flow) which may be supplied by multiple cylinders. In one or more embodiments, the system can collect information on lines exiting the manifold that are connected to a user's mask(s). In one or more embodiments, the system and methodology can monitor or otherwise determine the “Pack Potential” which is a measure of the amount of volume of air in the pack of cylinders based on the cylinder size and the pressure. This gives the user the ability to know the volume of air available, so if they have workers going out to do a job for three hours and they are going to use 100 cubic feet of air each, they know whether there is enough air available to perform the work. In another embodiment, reporting can be performed on the Pack Potential over a specified time. For instance, if a user is using a pack over several months, and the pack has been refilled several times, they can run a report for the specified time and get a full report of the amount of air that was used during that timeframe.

In one or more embodiments, the digital pressure sensor is battery powered.

In one or more embodiments, the digital pressure sensor is solar-powered.

In one or more embodiments, the system is user-configurable for a time schedule to send data at intervals ranging from every minute to every hour.

In one or more embodiments, the user-configurable time schedule includes options for sending data at intervals longer than an hour, such as daily or weekly.

In one or more embodiments, the air quality wireless device performs automated air quality testing at predefined intervals.

In one or more embodiments, the air quality wireless device includes a feature for manual air quality testing in addition to automated testing.

In one or more embodiments, the system enables displaying a graph of air usage over time on the remote monitoring station viewer.

In one or more embodiments, geofencing capabilities are provided that include customizable zones defined by the user.

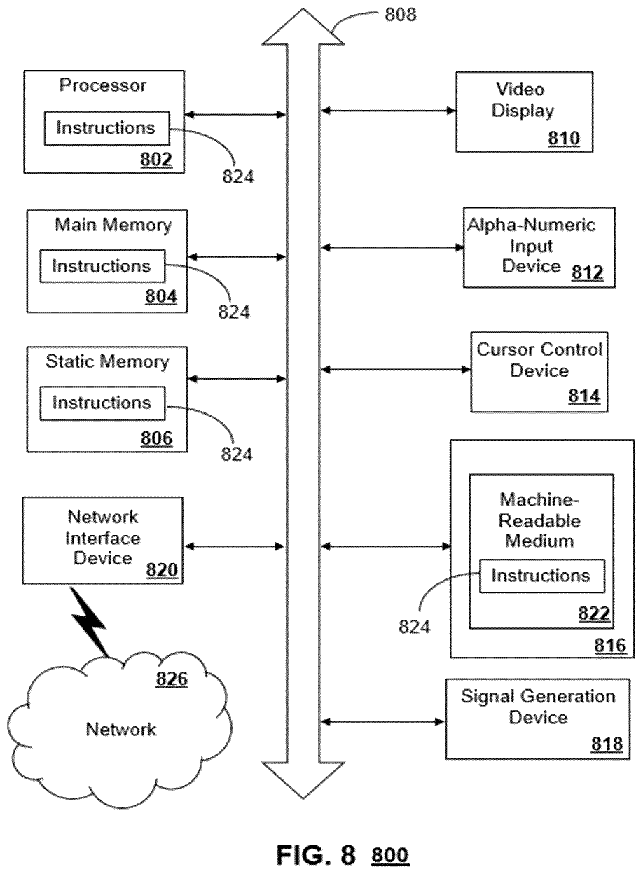

FIG. 8 depicts an exemplary diagrammatic representation of a machine in the form of a computer system 800 within which a set of instructions, when executed, may cause the machine to perform any one or more of the methods discussed above. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 800 may include a processor 802 (e.g., a central processing unit (CPU), a graphics processing unit (GPU, or both), a main memory 804 and a static memory 806, which communicate with each other via a bus 808. The computer system 800 may further include a video display unit 810 (e.g., a liquid crystal display (LCD), a flat panel, or a solid state display. The computer system 800 may include an input device 812 (e.g., a keyboard), a cursor control device 814 (e.g., a mouse), a disk drive unit 816, a signal generation device 818 (e.g., a speaker or remote control) and a network interface device 820.

The disk drive unit 816 may include a tangible computer-readable storage medium 822 on which is stored one or more sets of instructions (e.g., software 824) embodying any one or more of the methods or functions described herein, including those methods illustrated above. The instructions 824 may also reside, completely or at least partially, within the main memory 804, the static memory 806, and/or within the processor 802 during execution thereof by the computer system 800. The main memory 804 and the processor 802 also may constitute tangible computer-readable storage media.

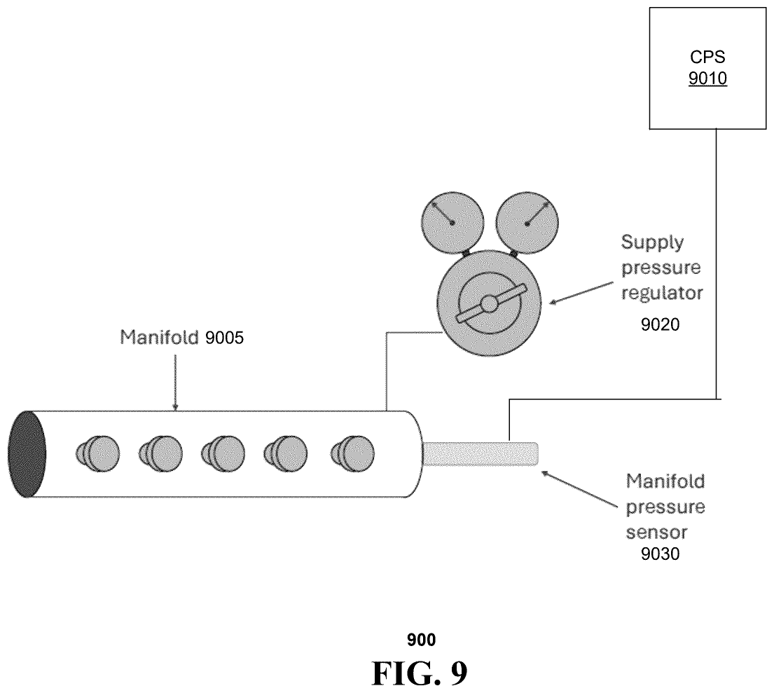

FIG. 9 illustrates a portion 900 of a system described herein (e.g., systems 100, 500, 600) that includes one or more CPS units 9010 such as CPS 1020, 2010, 5010, 6010 which can be installed with respect to the equipment (e.g., one or more packages of cylinders (not shown)), where the sensor(s) can determine pressure with respect to gas (e.g., air) that is sourced by the cylinders or sets of cylinders. In this example, a pressure regulator 9020 can be positioned for regulating pressure into the manifold 9005. A pressure sensor or set of pressure sensors 9030 can be positioned for determining manifold pressure (e.g., at or near the manifold 9005) or user pressure at the user masks (not shown), which can be a lower pressure as compared to the storage pressure of the cylinders and which could utilize lower pressure capacity sensors (which can be more sensitive to pressure changes).

In this example, the CPS 9010 can be connected to the pressure sensors 9030 and/or to an air quality tester(s) (e.g. coupled to the manifold or otherwise connected to the system to sample the gas/air (not shown)). The CPS unit 9010 can read pressure data, and can detect pressure and/or airflow with respect to the equipment, and/or analyze the quality of the air. It should be understood that various configurations and techniques can be utilized for connecting the pressure sensors 9030 and the cylinders of the equipment including utilizing a cascade arrangement, connecting pressure sensors to safety valves of each cylinder, connecting the pressure sensor to lines that are run from the safety valves, and/or connecting the pressure sensor to lines that are otherwise connected to the cylinders for airflow.

In one or more embodiments, the system and methodology enable monitoring pressure, air quality and/or other metrics at various points of the air delivery system, which can be employed for enabling proactive steps to improve performance of the system and ensuring safety. For example, pressure adjustments can be made (e.g., remotely via a command signal) where a pressure drop is detected going into a particular user mask or to manifold 9005. In another example, cylinder source adjustments (including closing of a valve of one or more of the cylinders) can be made (e.g., remotely via a command signal) where air quality of air going into a particular user mask or to manifold 9005 may be outside of a threshold which may be due to a particular cylinder or set of cylinders having lower air quality.

In one or more embodiments, the system and methodology enable the manifold pressure sensor 9030 to monitor the pressure of the outlet of the manifold 9005 (e.g., typically between 50-150 psi) to ensure that there is enough manifold pressure being supplied to the worker/tool(s). Since this pressure can change rapidly, the pressure readings and/or adjustments of the manifold can be updated/adjusted faster or more frequently than the storage pressure. One or more of the exemplary embodiments provide a safety core which allows for enhanced safety of breathing air. For example, the safety core can include logic enabling a storage pressure change override. The user can set the pressure sensor to check for pressure changes above a programmable level on a user programmable time. If the pressure change is over the set pressure level, the device will automatically send and update pressure reading(s) to the system, regardless of the next scheduled data transmission. As an example, if the scheduled data transmission is every 60 minutes and the pressure change variance is set to 50 psi, the smart safety check can be set for 30 minutes. In this example, at the time of the last data transmission, the sensor pressure readings could have been: Sensor 1—4000 psi, Sensor 2—3800 psi, Sensor 3—4000 psi. In this example, after 30 minutes the pressure readings have changed to: Sensor 1—4000 psi, Sensor 2—3800 psi, Sensor 3—3500 psi. In this scenario, the pressure sensor would send the updated pressure readings for all sensors, then set the next transmission time for 60 minutes.

In another embodiment, the safety core can include logic enabling a manifold pressure override. For example, the user can assign a specific sensor to the manifold pressure instead of the storage pressure. The manifold pressure (e.g., typically 50 to 150 psi) can be substantially lower than the storage pressure (e.g., typically 2300 to 6000 psi), so it requires a lower pressure change variance than the storage pressure. Also, since the manifold pressure can change more rapidly than the storage pressure, the pressure sensor can include a faster cycle time for testing the manifold pressure change. As an example: scheduled data transmission is every 60 minutes; pressure change variance is set to 50 psi; smart safety check is set for 30 minutes; manifold pressure variance is set to 10 psi; manifold smart safety check is set for 5 minutes. At the time of the last data transmission, the manifold pressure sensor was reading 100 psi in this example. After 5 minutes in this example, the manifold pressure readings had changed to 90 psi. This would result in the pressure sensor sending the updated pressure readings for all sensors, and then setting the next transmission time for 60 minutes.

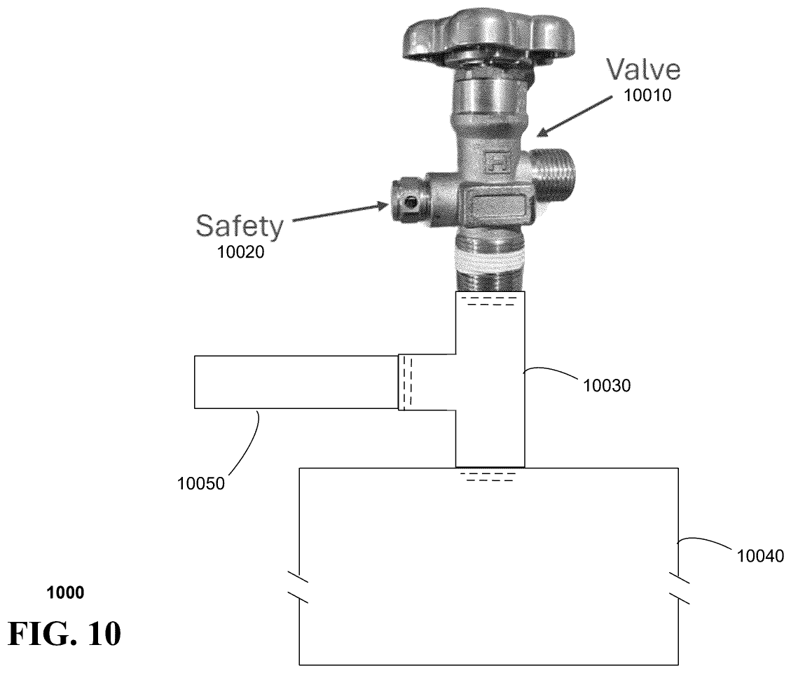

FIG. 10 illustrates a portion 1000 of a system described herein (e.g., systems 100, 500, 600) that includes one or more CPS units (not shown) such as CPS 1020, 2010, 5010, 6010, 9010 which can be installed with respect to the equipment (e.g., one or more packages of cylinders—only one of which is illustrated as cylinder 10040), where a pressure sensor(s) 10050 can determine pressure with respect to the cylinder or sets of cylinders. In this example, the pressure sensor 10050 can be positioned for determining storage pressure (e.g., at or near the pressurized cylinders 10040), which is a higher pressure and which could utilize higher pressure capacity sensors as compared to a manifold pressure (e.g., at or near the manifold (not shown)) or user pressure at the user masks (not shown), which is a lower pressure and which could utilize lower pressure capacity sensors (which can be more sensitive to pressure changes). A T-connector can be provided that connects with the cylinder 10040 and with a pressure valve 10010, and the T-connector allows for pressure sensor 10050 to determine the storage pressure (or pressure at the outlet of the cylinder). In this example, the use of the T-connector 10030 downstream of the cylinder and upstream of the pressure valve 10010 allows the safety valve 10020 (e.g., a pressure relief valve) to remain fully operational and to remain in the outlet flow path from the cylinder 10040. Many certifications require this arrangement and system portion 1000 illustrates a configuration that allows for maintaining a safety certification through use of safety valve 10020 while also obtaining pressure readings via a pressure sensor at the outlet of the cylinder 10040. System portion 1000 can be utilized with various pressure valves 10010 including those with built-in pressure relief valves and pressure relief valves that utilize proprietary threads. As explained herein, the pressure sensor 10050 can provide its collected data to the CPS for distribution to relevant recipients.

FIG. 11 illustrates a portion 1100 of a system described herein (e.g., systems 100, 500, 600, 900, 1000) that includes one or more CPS units 11010 such as CPS 1020, 2010, 5010, 6010, 9010 which can be installed with respect to the equipment (e.g., one or more packages of cylinders 11040), where the sensor(s) can determine pressure with respect to gas (e.g., air) that is sourced by the cylinders or sets of cylinders. In this example, a supply pressure regulator 11020 can be positioned for regulating pressure at an inlet of the manifold 9005. A pressure sensor or set of pressure sensors 11030 can be positioned for determining manifold pressure (e.g., at or near the manifold 9005) or user pressure at the user masks (not shown), which can be a lower pressure as compared to the storage pressure of the cylinders 11040 and which could utilize lower pressure capacity sensors (which can be more sensitive to pressure changes). Additionally, a pressure sensor or set of pressure sensors 11025 can be positioned for determining high pressure manifold pressure (e.g., at or near the high pressure manifold connected to the cylinders 11040), which can be a higher pressure (e.g., a storage pressure) as compared to the lower pressure at the manifold 11005 and which could utilize higher pressure capacity sensors. As an example, a single high pressure sensor 11025 can be utilized and connected to the high pressure manifold for monitoring storage pressure.

In this example, the CPS 11010 can be connected to or otherwise in communication with the pressure sensors 11025, 11030 and/or to an air quality tester(s) 11050 (e.g., illustrated as being coupled between the high pressure manifold and the supply pressure regulator 11020, although other configurations and points of connection can be utilized for collecting a sample of the gas/air). The CPS unit 11010 can read pressure data, and can detect pressure and/or airflow with respect to the equipment, and/or analyze the quality of the air. It should be understood that various configurations and techniques can be utilized for connecting the pressure sensors 11025, 11030 and the cylinders 11040 of the equipment including utilizing a cascade arrangement, connecting pressure sensors to safety valves of each cylinder, connecting the pressure sensor to lines that are run from the safety valves, and/or connecting the pressure sensor to lines that are otherwise connected to the cylinders for airflow.

In one or more embodiments, the system and methodology enable monitoring pressure, air quality and/or other metrics at various points of the air delivery system, which can be employed for enabling proactive steps to improve performance of the system and ensuring safety. For example, pressure adjustments can be made (e.g., remotely via a command signal) where a pressure drop is detected going into a particular user mask or to manifold 11005. In another example, cylinder source adjustments (including closing of a valve of one or more of the cylinders 11040) can be made (e.g., remotely via a command signal) where air quality of air going into a particular user mask or to manifold 11005 may be outside of a threshold which may be due to a particular cylinder or set of cylinders having lower air quality.

FIG. 12 illustrates a portion 1200 of a system described herein (e.g., systems 100, 500, 600, 900, 1000) that includes one or more CPS units 12010 such as CPS 1020, 2010, 5010, 6010, 9010 which can be installed with respect to the equipment (e.g., one or more packages of cylinders 12040), where the sensor(s) can determine pressure with respect to gas (e.g., air) that is sourced by the cylinders or sets of cylinders. FIG. 12 is similar to FIG. 11 with respect to its use and positioning of various components for monitoring air pressure and quality for air sourced from cylinders 12040 including the manifold 12005, the CPS 12010, the supply pressure regulator 12020, the low pressure manifold pressure sensor 12030, and the air quality check device 12050.

In this example, a set of pressure sensors 12025 can be positioned for determining the storage pressure (e.g., at or near the high pressure manifold connected to the cylinders 11040), which can be a higher pressure (e.g., a storage pressure) as compared to the lower pressure at the manifold 11005 and which could utilize higher pressure capacity sensors. In this example, the high pressure sensors 12025 can be connected to the cylinders 12040, such as through a T-connector as shown in FIG. 10.

In this example, the CPS 12010 can be connected to or otherwise in communication with the pressure sensors 12025, 12030 and/or to an air quality tester(s) 12050 (e.g., illustrated as being coupled between the high pressure manifold and the supply pressure regulator 12020, although other configurations and points of connection can be utilized for collecting a sample of the gas/air). The CPS unit 12010 can read pressure data, and can detect pressure and/or airflow with respect to the equipment, and/or analyze the quality of the air. It should be understood that various configurations and techniques can be utilized for connecting the pressure sensors 12025, 12030 and the cylinders 12040 of the equipment including utilizing a cascade arrangement, connecting pressure sensors to safety valves of each cylinder, connecting the pressure sensor to lines that are run from the safety valves, and/or connecting the pressure sensor to lines that are otherwise connected to the cylinders for airflow.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

While the tangible computer-readable storage medium 822 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., WiMAX, GSM, CDMA) are contemplated for use by a computer system.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method comprising:
receiving, by a processing system including a processor, pressure data over a network from a monitoring device connected to pressure sensors that are connected to pressurized tanks; and
providing, by the processing system, the pressure data to a communication device for presentation.

2. The method of claim 1, wherein the receiving the pressure data is according to a schedule.

3. The method of claim 1, wherein the receiving the pressure data is according to a pressure measurement being below a pressure threshold.

4. The method of claim 1, comprising:
receiving, by the processing system, location data over the network from the monitoring device, the location data representative of a location of the pressurized tanks; and
providing, by the processing system, the location data to the communication device for presentation.

5. The method of claim 4, wherein the receiving the location data is according to a schedule.

6. The method of claim 4, wherein the receiving the location data is according to a detection that the location data is outside of an authorized area.

7. The method of claim 1, comprising:
receiving, by the processing system, air quality data over the network from the monitoring device, the air quality data representative of an air quality associated with the pressurized tanks; and
providing, by the processing system, the air quality data to the communication device for presentation.

8. The method of claim 7, wherein the receiving the air quality data is according to a schedule.

9. The method of claim 7, wherein the receiving the air quality data is according to an air quality measurement not satisfying a quality threshold.

10. A device, comprising:
a processing system including a processor; and
a memory that stores executable instructions that, when executed by the processing system, facilitate performance of operations, the operations comprising:
receiving data from a group of sensors that are connected to pressurized cylinders; and
wirelessly transmitting, over a network, the data to a management platform that causes the management platform to make the data accessible to one or more communication devices.

11. The device of claim 10, wherein the data includes pressure information and air quality information and wherein the operations further comprise receiving a command signal from the management platform that causes one of a pressure adjustment or a cylinder source adjustment.

12. The device of claim 10, wherein the operations comprise wirelessly transmitting, over the network, location data to the management platform, the location data being representative of a location of the pressurized cylinders.

13. The device of claim 10, wherein the operations comprise determining a schedule for delivering the data to the management platform, wherein the wirelessly transmitting of the data is performed according to the schedule.

14. The device of claim 10, wherein the operations comprise analyzing the data to determine whether the data is outside of a threshold range.

15. The device of claim 10, wherein the group of sensors includes a pressure sensor that is connected to a safety valve of one of the pressurized cylinders.

16. The device of claim 10, wherein the group of sensors includes an air flow sensor that is connected downstream of the pressurized cylinders.

17. The device of claim 10, wherein the group of sensors includes an air quality sensor, or includes a pressure sensor that is connected to a T-connector that is connected to one of the pressurized cylinders.

18. A non-transitory machine-readable medium, comprising executable instructions that, when executed by a processing system including a processor, facilitate performance of operations, the operations comprising:
receiving data over a network from a monitoring device connected to sensors that are connected to pressurized tanks;
providing the data to a communication device for presentation;
analyzing the data according to a threshold; and
in response to the data failing to satisfy the threshold transmitting a notification to an end user device.

19. The non-transitory machine-readable medium of claim 18, wherein the data includes pressure data, air quality data, and location data.

20. The non-transitory machine-readable medium of claim 18, wherein the operations further comprise:
receiving a request to adjust a schedule for delivering the data; and
transmitting the request to the monitoring device which causes the monitoring device to adjust a delivery schedule for the data.
